(19) United States
(12) Patent Application Publication
(10) Pub. No.: US 2010/0024764 A1
(43) Pub. Date: Feb. 4, 2010

(54) THERMAL ENGINE

(75) Inventor: Gert Joachim REINHARDT, Oetigheim (DE)

Correspondence Address: Paul D. Greeley;Ohlandt, Greeley, Ruggiero & Perle, L.L.P., 10th Floor, One Landmark Square, Stamford, CT, 06901-2682, US

(73) Assignee: Gaby Traute REINHARDT

(21) Appl. No.: 12/508,880

(22) Filed: Jul. 24, 2009

Related U.S. Application Data
(60) Provisional application No. 61/195,562, filed on Oct. 8, 2008.

(30) Foreign Application Priority Data
Aug. 1, 2008 (DE) 10 2008 036 024.4

(51) Int. Cl. F02B 53/00; F01K 13/00

(52) U.S. Cl. 123/204; 60/645

(57) ABSTRACT

A thermal engine that comprises a rotary element. A plurality of drive elements are arranged in the rotary element. Each drive has a plurality of piston/cylinder arranged around a common central expansion space. Piston heads of the pistons abut on a power transmission surface of the rotary element in order to drive the same.

### CROSS-REFERENCED APPLICATIONS

The present application claims priority to German Patent Application No. DE 10 2008 036 024.4, filed on Aug. 1, 2008, and U.S. Provisional Application No. 61/195,562, filed on Oct. 8, 2008, both of which are incorporated herein in their entirety.

### BACKGROUND OF THE DISCLOSURE

1. Field of the Disclosure

The disclosure refers to a thermal engine such as an internal combustion engine and/or a steam engine. Specifically, the thermal engine is a generator.

2. Description of Related Art

Conventional internal combustion engines comprise a rotary element such as a crankshaft. The rotary element is typically connected with a plurality of piston/cylinder units for rotational driving. Here, the piston/cylinder units are arranged in a line or under an angle with respect to each other to form an in-line engine or a V-type engine, respectively. In such engines, the piston rods of the piston/cylinder units extend in a plane substantially perpendicular to the longitudinal axis of the crankshaft. The rotary element is further connected with a flywheel in order to guarantee a uniform rotational movement and to force the pistons in the cylinders back for a compression of the fuel in the combustion space.

With thermal engines designed as steam engines and steam turbines, water is heated to become water vapor. The water vapor expands in expansion spaces. This causes the movement of the piston or the turbine wheel.

Turbines connected with a generator for the generation of electricity may possibly have an efficiency of about 40%.

Further, gas turbines are known, that also achieve an efficiency of about 40% when coupled with a generator. An increase in efficiency may be achieved by coupling a gas turbine and a steam turbine. However, such coupled arrangements of gas and steam turbines are technically complex and large-volume units.

### SUMMARY

It is an object of the disclosure to provide a thermal engine with small overall dimensions and high efficiency.

The object is achieved with a thermal engine wherein, according to the disclosure, the rotary element preferably surrounds a plurality of drive means or the drive means are arranged within the rotary element, respectively. Each of the drive means provided within the rotary element comprises a plurality of piston/cylinder units. According to the disclosure, the cylinders of a drive means are in communication with a centrally arranged expansion or combustion space. The explosion of a fuel/air mixture in the expansion space, for example, causes an outward directed movement of the pistons in the cylinders. Since the pistons are connected with the rotary element, and especially abut a power transmission surface of the rotary element, the outward movement of the piston with respect to the expansion space causes a rotation of the rotary element. This arrangement leads to a compact structure.

The preferably at least two drive means of the present engine preferably have three cylinders each. The cylinders, and thus the cylinder/piston unit, is preferably arranged in a star-shaped configuration around the central expansion space. Thereby, a uniform transmission of power to the rotary element can be obtained. It is particularly preferred for the piston/cylinder unit to be arranged in one plane per drive means and that the planes of adjacent drive means are preferably formed in parallel to each other. In this preferred embodiment, the rotary element is preferably of cylindrical or elongate design. Here, the rotary element rotates around a central axis preferably extending through the expansion spaces. In this case, the rotary element preferably has a uniform cross section along the central axis.

However, it is also possible to arrange the individual piston/cylinder units of the individual drive means not in a plane, but under angles with respect to each other. This allows a further reduction of the overall dimensions of the present internal combustion engine. In this embodiment, the power transmission surface of the rotary element has to be adapted correspondingly so that the power transmission is effected with as little loss as possible.

The rotary element has a power transmission surface preferably situated on the inner side of the rotary element. The pistons or a piston surface of the piston heads of the pistons preferably abuts the power transmission surface. In a particularly preferred embodiment, the rotary element has a corrugated structure or a surface having a corrugated structure. The piston heads abut this surface, which in particular is the power transmission surface of the rotary element. In cross section, the corrugated structure preferably has bulges and recesses. When the pistons are at the lower dead centre, the piston heads abut the bulges that are directed towards the piston or the respective expansion space of the drive means. Accordingly, the piston heads abut the recesses that are directed away from the respective expansion space, when the pistons are at the upper dead centre. Expansions of the pistons, i.e. displacements of the piston from the position of the lower dead centre to the position of the upper dead centre, causes force to be transmitted onto the rotary element, the rotary element being set to a rotary movement by the linear forces directed outward with respect to the expansion space.

In a preferred embodiment, the pistons of a drive means have a common expansion or combustion space. Here, an expansion or explosion of the propelling medium causes a preferably synchronous outward movement of the pistons. Due to the outward movement, the pistons reach the upper dead centre where they abut the recesses in the corrugated structure. Rotating the rotary element further, the pistons are again forced inward to the lower dead centre until the pistons abut the bulges facing towards the expansion space.

The piston/cylinder units are preferably arranged in a star-shaped array in a plane and, in particular, at equal angles to each other. Thereby, a uniform power transmission onto the rotary element can be achieved.

In a preferred embodiment, the central expansion space has a plurality of expansion spaces. Each expansion chamber is connected to one or a plurality of piston/cylinder units. When the expansion spaces are designed as combustion spaces, it is possible to cause a consecutive explosion of the combustion medium in the expansion chambers, or to perform a consecutive ignition. This is advantageous in that the heat occurring with the explosion can be dissipated better and may thus be used at the same time to pre-heat or gasify the fuel in the other chambers. In this case, the power transmission surface of the rotary element must be adapted to the expansion times. In this embodiment, the power transmission surface of the rotary element that describes a motion path of the pistons, usually is not symmetrical. Moreover, in this embodiment, the angles between the individual piston/cylinder means may not be constant. Further, it may be advantageous, especially with this embodiment, if not all piston/cylinder units abut the same motion path defined by the power transmission surface of the rotary element.

In order to eliminate a flywheel or the like, the disclosure preferably provides several drive means. In a preferred embodiment, these are arranged offset or rotated with respect to each other such that the cylinders of the individual drive means are at the lower dead center, for example, at different times. Per drive means, the outward displacement of the pistons is preferably synchronous and, with respect to the individual drive means, the displacement preferably is offset in time. In particular, all piston/cylinder units of a drive means are arranged offset by the same angle with respect to a neighboring drive means. Here, the bulges and recesses of adjacent drive means can be of identical design and be aligned vertical to the direction of rotation, i.e. they can be not offset relative to one another.

Alternatively it is also possible to arrange the piston/cylinder units of adjacent drive means not in an offset manner but in parallel to each other, the respective adjacent bulges and recesses then being arranged under an angle or rotated with respect to each other. Of course, these two embodiments can also be combined so that both the piston/cylinder units of adjacent drive means and the bulges and recesses of adjacent means are offset from each other.

Preferably, at least some of the expansion spaces are combustion spaces. The expansion spaces designed as combustion spaces are supplied with a fuel, such as an gas/air mixture, which is ignited to expand or which is self-igniting. At least one of the expansion spaces can be designed as a steam expansion space.

Thus, the disclosure allows to design all expansion spaces as combustion spaces or to design all expansion spaces as steam expansion spaces. Likewise, some of the expansion spaces can be designed a combustion spaces and others can be designed as steam expansion spaces.

In another embodiment of the disclosure, some individual drive means thus have a central, in particular common combustion space, and some individual drive means have a central, in particular common steam expansion space. It is preferred in this instance that the heat generated in the combustion spaces by the combustion or explosion of the fuel is used to vaporize a medium such as water. The waste heat of the combustion spaces thus serves to supply heat to the water-vapor circuit.

In a particularly preferred embodiment, the expansion space comprises several expansion chambers as explained above, wherein, in this embodiment, some of the chambers are configured as combustion chambers and some of the chambers are designed as expansion chambers. The expansion chambers, which in particular hold water or water vapor, preferably enclose the combustion chamber partly so that the heat generated during combustion can directly be used to heat the water or the water vapor. This drastically reduces heat losses. In this particularly preferred embodiment, the pistons are moved due to the expansion of the medium, preferably with an offset in time. In particular, the expansion in the steam expansion chambers occurs after the expansion in the combustion chambers. In this case, it is preferred that the pistons connected with the combustion camber abut another path of the rotary element that the pistons connected with the steam expansion chamber.

It is particularly preferred for a drive means according to the disclosure to have one piston/cylinder unit connected with a combustion chamber and two piston/cylinder units connected with a gas expansion chamber. Here, the cross section of the piston or the volume of the combustion chamber can be larger than the cross section of the two pistons connected with the steam expansion chamber. The piston head of the piston connected with the combustion chamber is preferably connected with two pins, each pin abutting a guide path of the rotary element. The two guide paths are preferably identical. Preferably, the guide path for the two other pistons connected with the steam expansion chamber is provided between these two guide paths. The three pistons of a drive means provided in this embodiment are still arranged in one plane, wherein, due to the expansion space being divided into at least one combustion chamber and at least one steam expansion chamber, an integration of an internal combustion engine with a steam engine is realized.

It is particularly preferred to design the entire internal combustion engine, which in a preferred embodiment comprises combustion spaces and steam expansion spaces, as a sphere so that the outer shape substantially corresponds to a sphere. In this case, the individual drive means and the individual piston/cylinder units of the drive means are arranged within the sphere in a space-saving manner. This allows to obtain an extremely compact powerful engine or generator. The rotary element itself may be designed as a sphere.

In a particularly preferred embodiment of the thermal engine, the rotary element can be connected with a generator means. Here, it is particularly preferred that the generator means surrounds the rotary element and that it is of spherical shape as well.

In another thermal engine, which is an independent disclosure, it is provided to connect a rotary element with a shaft. The rotary element has a corrugated power transmission surface, a piston rod of at least one piston/cylinder unit of a drive means abutting on the power transmission surface. An expansion in the expansion space of the piston/cylinder unit causes a corresponding movement of the piston rod. The linear movement of the piston rod is transformed into a rotational movement of the shaft by the rotary element via the corrugated power transmission surface. According to the disclosure, the at least one piston/cylinder unit is arranged substantially parallel to a longitudinal axis of the shaft. Different from conventional internal combustion engines, in which the piston/cylinder unit is arranged substantially in a plane perpendicular to the longitudinal axis of the shaft, the force transmitted through the piston rod substantially acts in the direction of the longitudinal axis of the shaft. Thus, no connecting rod has to be provided. According to the disclosure, a plurality of piston/cylinder units is preferably provided per drive means, the two piston rods substantially extending parallel to the longitudinal axis of the shaft. In this case, the pistons may extend under an angle of up to 20° to the longitudinal axis.

Preferably, the plurality of piston/cylinder units of a drive means surround the longitudinal axis of the shaft. In particular, the piston/cylinder units are arranged on a circular line surrounding the longitudinal axis of the shaft. Here, it is particularly preferred that the piston/cylinder units are distributed regularly about the longitudinal axis. Thereby, a very uniform transmission of force onto the power transmission surface and thus on the rotary element or the shaft can be obtained. It is particularly preferred in this context that the piston/cylinder units are arranged relative to the corrugated power transmission surface such that the pistons are in different operational states. Thus, the design of the corrugated power transmission surface is tuned to the position of the piston/cylinder units.

The corrugated design of the power transmission surface thus substantially corresponds to the lower dead centers of the piston/cylinder units in the wave trough and to the upper dead centers thereof at the wave crests.

In a particularly preferred embodiment, the piston/cylinder units of a drive means comprise different strokes. In particular, at least two different types of piston/cylinder units are provided so that two different strokes are realized. It is preferred in this context that piston/cylinder units with a shorter stroke are connected with a steam expansion space. According to the disclosure, piston/cylinder units with longer strokes are preferably connected with combustion spaces. In this particularly preferred embodiment of the present thermal engine, it is thus possible to perform expansions based on steam and combustion in a single drive means. Thus, a combination of a steam and an internal combustion engine is realized in minimum space so that an extremely compact thermal engine with a very high efficiency is realized. It is preferred that the piston/cylinder units connected with a steam expansion space are positioned in alternation with those connected with a combustion space along the circular line surrounding the longitudinal axis of the shaft.

In a particularly preferred embodiment of the disclosure, a plurality of drive means is provided. Here, it is particularly preferred that the drive means again comprise a combination of piston/cylinder units operated with steam and combustion gas.

The individual drive means preferably cooperate with separate rotary elements. The rotary elements may be connected with a common shaft or with separate shafts.

In a preferred embodiment, an inner drive means and an outer drive means, surrounding the inner drive means, are provided. It is preferred in this context that both drive means comprise a plurality of piston/cylinder units arranged on a circular line. This allows to realize a very powerful engine of compact structure.

In another embodiment, two drive means are arranged opposite each other. Here, the direction of movement of the respective piston rods upon expansion is substantially opposite to each other. The two drive means are respectively connected with a rotary element, the two rotary elements preferably being connected with two different shafts. This embodiment has the particular advantage that forces occurring upon expansion are directed opposite to each other and that opposite piston/cylinder units thus support each other.

It particularly preferred to combine the two above described embodiments so that, for example, four drive means are provided, i.e. two inner and two outer drive means, the two inner and the two outer drive means being arranged opposite each other, respectively.

In a development of the disclosure, a generator may be realized by connecting the rotary element(s) and/or the shaft(s) with a generator means.

The above described preferred embodiments of the disclosure are preferably operated with combustible gas and/or steam. These drive media are introduced into the central expansion chamber and will effect a displacement of the pistons arranged in the cylinder connected to the expansion chamber. However, according to the disclosure, the pistons can also be moved by air pressure. It is possible to introduce air into the expansion chamber. For this purpose, the expansion chamber can be connected, e.g., to a funnel. For generating the air pressure, wind will enter the funnel; thus, the system of the disclosure can also be operated as a wind power station. In this manner, driving the rotation element is possible in an extremely simple and effective fashion. The rotation element can then also be connected to a generator for generating electric current.

Further, it is possible to supply water to the expansion chamber, while the flow of the water will be effective to move the pistons. Herein, use can be made of the lifting and lowering of a water level according to the principle of a tidal power plant.

### BRIEF DESCRIPTION OF THE DRAWINGS

The following is a detailed description of the disclosure with reference to preferred embodiments and to the accompanying drawings.

FIG. 1 is a schematic perspective view of a first embodiment,

FIG. 2 is a schematic perspective view of the first embodiment in a partly sectional view,

FIG. 3 is a schematic section through the first preferred embodiment in top plan view,

FIG. 4 is a schematic top plan view on the first preferred embodiment.

FIG. 5 is a schematic perspective view of the first embodiment with a generator unit illustrated in addition,

FIG. 6 is a schematic perspective sectional view of a second embodiment showing half of the entire embodiment,

FIG. 7 is a sectional top plan view of the embodiment illustrated in FIG. 6,

FIG. 8 is a simplified schematic perspective view of a third embodiment of the present thermal engine,

FIG. 9 is a schematic perspective view of the rotary element of the embodiment illustrated in FIG. 8,

FIG. 10 is a schematic perspective half section of the drive means of the embodiment illustrated in FIG. 8,

FIG. 11 is a schematic perspective view of an alternative drive means suited for use in the third embodiment,

FIG. 12 is a schematic perspective view of the third embodiment with the alternative drive means of FIG. 1 and a generator unit,

FIGS. 13 and 14 illustrate further possible embodiments of the arrangement of the piston/cylinder units,

FIG. 15 is a schematic section through another embodiment of a thermal engine that represents an independent disclosure,

FIG. 16 is a schematic illustration of a development of the embodiment illustrated in FIG. 15, and

FIG. 17 is a schematic top plan view on two rotary elements used in the embodiment illustrated in FIG. 16.

### DETAILED DESCRIPTION OF PREFERRED EMBODIMENT

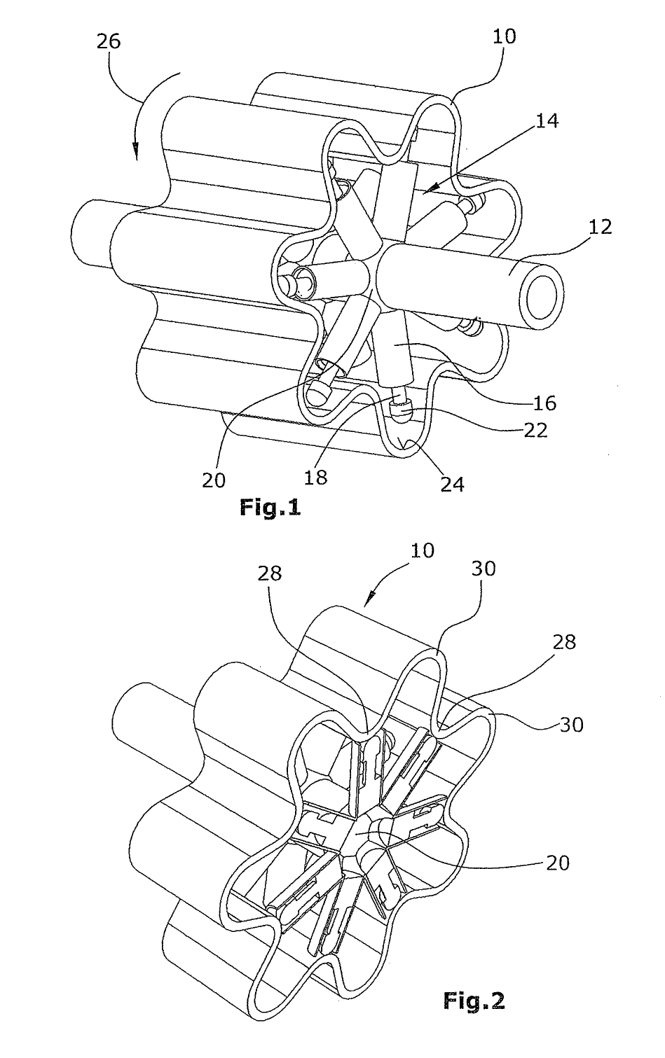

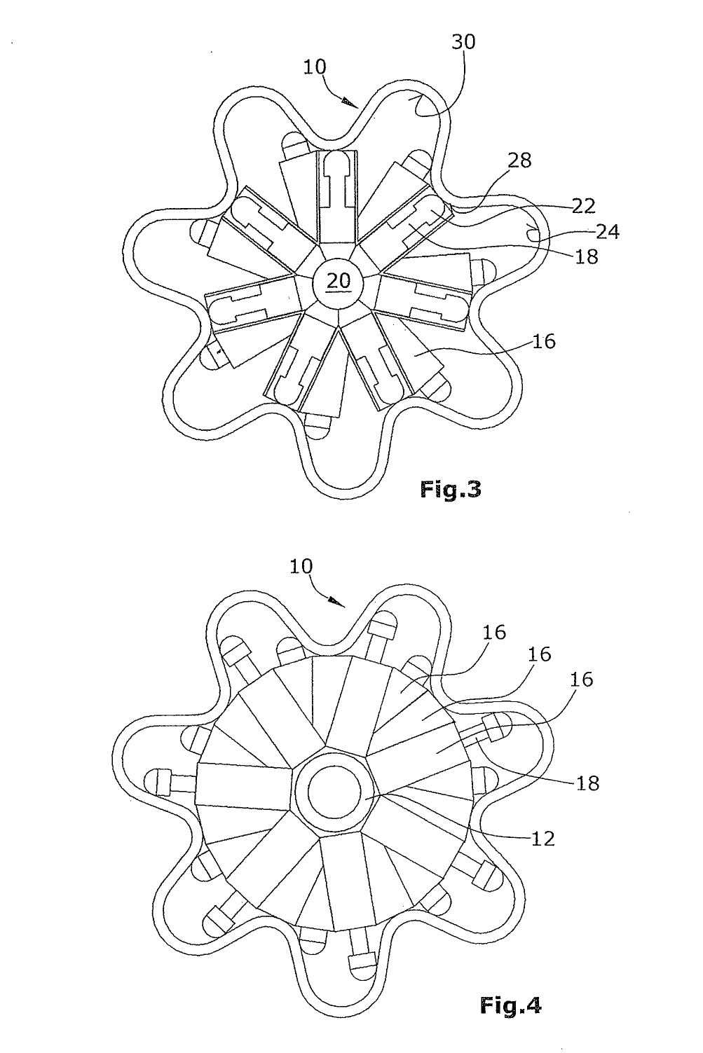

In the first preferred embodiment (FIGS. 1 to 4), a non-rotating axis 12 is arranged in a rotary element 10. A plurality of star-shaped drive means 14 is provided around the axis. In the embodiment illustrated, each drive means comprises seven piston/cylinder means, each having a cylinder 16 in which a piston 18 is arranged. The piston/cylinder means 16, 18 are arranged in a star-shape and have a common combustion space 20 that is substantially formed as a part of the axis 12. Through the hollow axis 12, fuel supply lines may be guided to the expansion and combustion spaces 20, for example. Similarly, exhaust gas lines are guided through the hollow axis. The expansion of the propelling medium, such as a fuel/gas mixture, in the expansion space 20, all pistons 18 are pushed outward. Since the piston heads 22 of the individual pistons 18 abut a power transmission surface 24 of a corrugated shape, without being fixedly connected thereto, however, an expansion of the pistons, i.e. an outward displacement of the pistons, causes a rotation of the rotary element 10 in the direction of the arrow 26 about the stationary shaft 12.

According to the disclosure, a plurality of drive means is arranged in succession with respect to the shaft 12, the piston/cylinder means 16, 18 preferably being offset from each other under a constant angle. Thus, in top plan view, the individual drive means 14 are arranged rotated by the same angle. The rotation is caused by the rotary element 10 having bulges 28 directed towards the expansion space 20 and recesses 20 between the bulges 28. Thus, bulges 28 and recesses 30 are arranged alternately along the circumference of the rotary element, the arrangement especially being symmetric with constant angular distances between the bulges and recesses.

Thus, a uniform rotation of the rotary element 10 can be obtained by a successive ignition of the combustion medium in the expansion spaces 20 of the preferably three drive means 14.

FIGS. 3 and 4 in particular show that the individual drive means each comprise piston/cylinder means 16, 18 arranged in a star-shape and having a respective central combustion space 20. The individual drive means 10 are rotated with respect to each other, especially by the same angle. Thereby, each of the pistons of the individual drive means 10 assumes a different position. Specifically, only the pistons of one drive means 14 are at the lower or upper dead centre, respectively. When more than two, especially three drive means are provided, the pistons of one drive means are at the upper dead centre, the pistons of another drive means are at the lower dead centre and the pistons of the third are between the two dead centers.

The rotational movement of the rotary element 10 may be transmitted to a drive shaft via an interposed transmission or the like, for example. Likewise, it is conceivable to make the rotary element stationary and to thus realize a rotation of a shaft supported on the shaft 12.

Further, the expansion spaces 20 can comprise a plurality of expansion chambers. Here, for example, all chambers of an expansion space 20 may be designed as combustion chambers. This allows for a successive ignition in the individual chambers, in order to achieve an improved heat dissipation. In this embodiment, the rotary element is no longer of rotationally symmetric design, and/or the angles between the individual piston/cylinder means 16, 18 of a drive means 14 no longer show a constant angle with respect to each other.

The rotary element 10 is preferably connected with a generator means, e.g. by interposition of a transmission. It is particularly preferred for the rotary element 10 to be surrounded by a generator means that may be designed as a substantially cylindrical component, corresponding to the rotary element. Preferably, the generator unit is formed as a substantially spherical unit and may also be supported on the shaft 12.

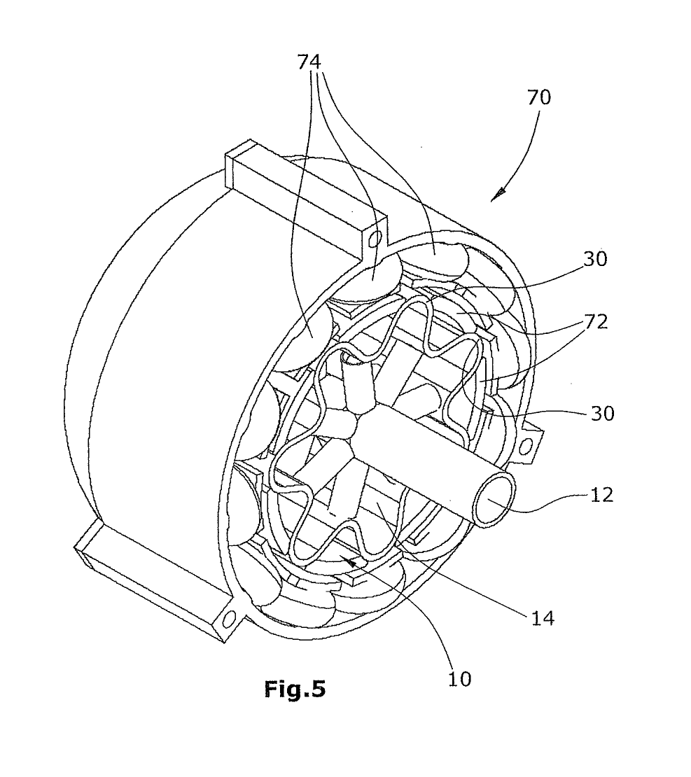

For the generation of current, the embodiment illustrated in FIGS. 1 to 4 may be surrounded by a generator unit 70, as illustrated in FIG. 5. To do this, the rotary element 10 is connected with magnets 72. The individual magnets 72 are arranged between the recesses 30 of the rotary element 10 and are rotated around the shaft 12 together with the rotary element 10. Further, the generator unit 70 has coils 74 into which current is induced due to the movement of the magnets 72.

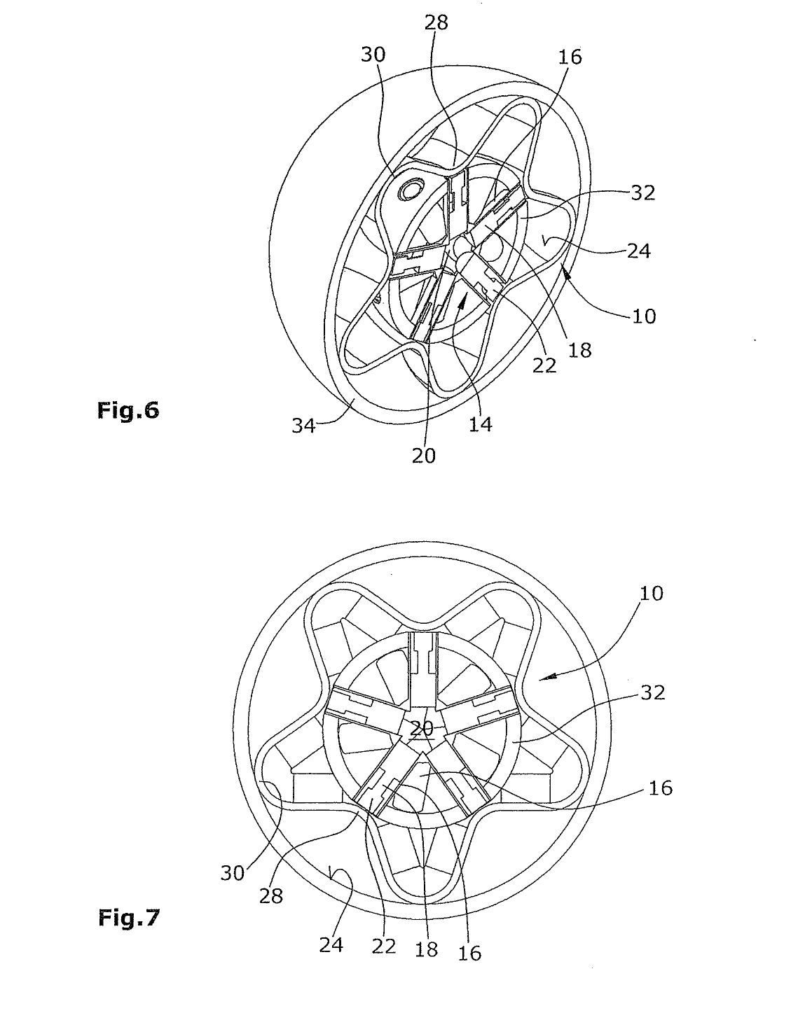

In the second embodiment (FIGS. 6 and 7), the same or similar components are identified by the same reference numerals. The essential difference between this embodiment and the first preferred embodiment (FIGS. 1 to 4) is that the internal combustion engine of the disclosure is spherical in shape. Thus, unlike the first embodiment (FIGS. 1 to 5), the rotary element does not have a constant cross section in the longitudinal direction, but is of spherical design. Within an inner sphere 32 illustrated in the present embodiment yet not ultimately necessary, the drive means 14 are arranged, comprising a plurality of piston/cylinder means 16, 18, e.g. five in the embodiment illustrated. In the embodiment illustrated, three drive means 14 are provided, one of which is illustrated in section, one is illustrated in the background and the third one is not visible since it is provided in the non-illustrated half of the internal combustion engine of this embodiment. The rotary element of this embodiment also comprises a power transmission surface 24 with a corrugated or wave-shaped structure. However, the same is spherical and encloses the inner sphere 32 which in particular serves to fix the cylinders 16. An outer sphere 34 is provided especially for supporting the rotary element 10.

In the second embodiment (FIGS. 6 and 7) it is also possible to modify the central expansion chamber 20 such that a plurality of expansion chambers are provided. These may, as explained above, may be designed as combustion chambers or steam expansion chambers, or they may be arranged correspondingly with respect to each other. The expansion of the steam can be controlled such that it happens successively in the individual chambers.

Also in this embodiment, it is particularly preferred to have a generator unit surround the rotary element 10. Here, in a particularly preferred embodiment, the generator unit is shaped corresponding to the sphere 34 and preferably surrounds the rotary element completely.

The supply of the respective media to the chamber 42, 46 is achieved by lines 58, 58, 60 (FIG. 7). For example, gas is supplied via line 56 to the combustion chambers within an expansion space provided in the sphere 57. Exhaust gas can be discharged via line 58. Further, a supply of air is possible via line 60. The remaining open space 61 may further be used as a supply channel for water refill, as a service chamber or the like.

The lines 56, 58, 60 are arranged within the stationary shaft 12. In the embodiment illustrated, the shaft further has bearing means 62 in the shape of ball bearings. A sphere 34 is connected with the ball bearings 62, as illustrated for the embodiments in FIGS. 6 and 7, the sphere 34 carrying the rotary element or being formed integrally therewith.

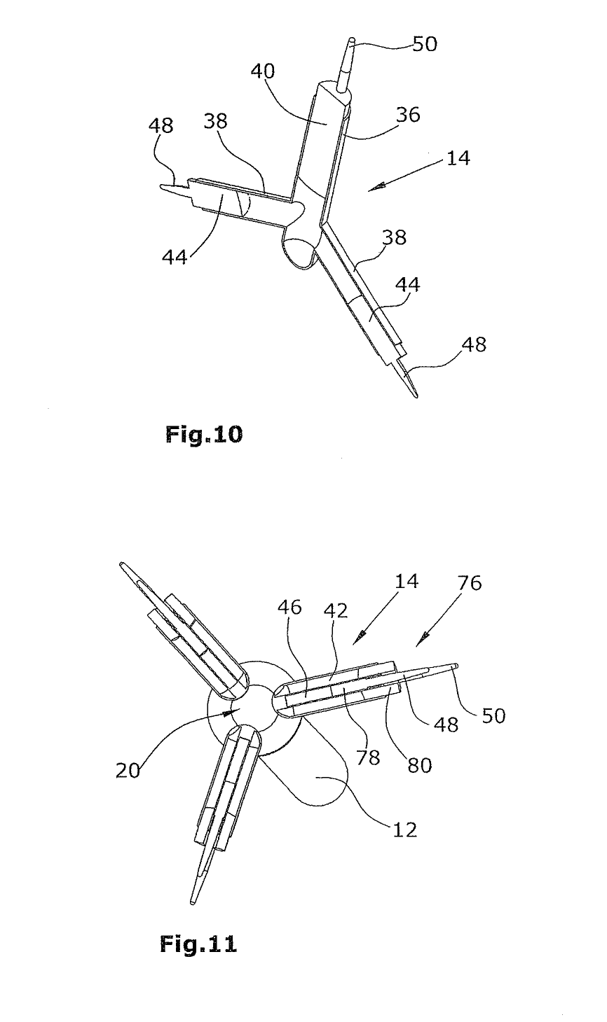

In an alternative embodiment of the drive means 14 (FIG. 11) double piston means 76 are provided. Each double piston means 76 has an inner piston 78 as well a piston 80 of annular cross section and surrounding the inner piston 78. The inner piston 78 has a pin 48 corresponding to the pin 48 of the piston 44 (FIG. 10). Likewise, the outer annular piston 80 has two double pins 50 corresponding to the double pin 50 of the piston 40 (FIG. 10). In this preferred embodiment, the inner piston 78 can be connected with a steam expansion chamber 46 and the annular piston 80 may be connected with a combustion chamber 42. The corresponding chambers may be combined inside the shaft 12 to a central expansion space 20 with several chambers.

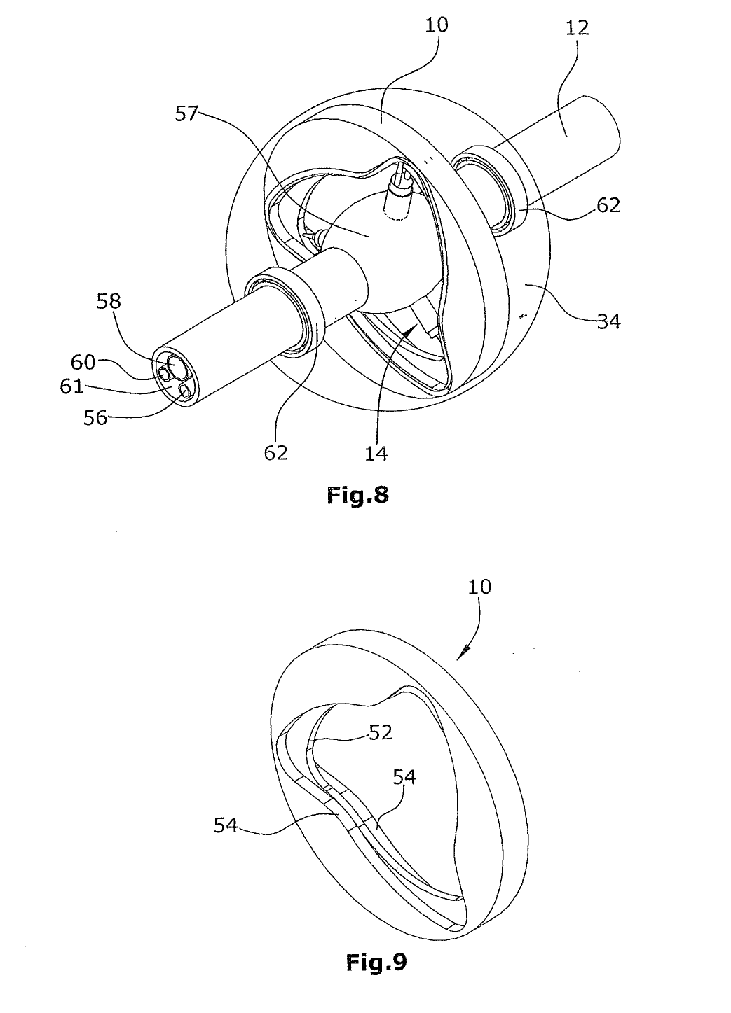

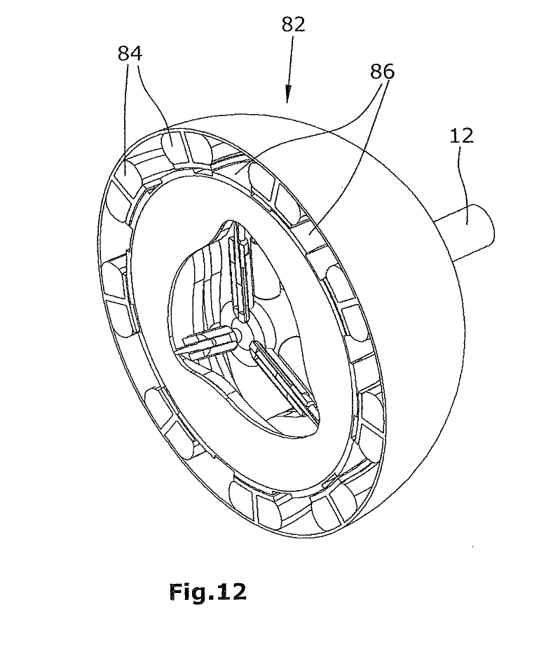

The embodiment illustrated in FIGS. 8 to 10 or the alternative embodiment in FIG. 11 preferably also comprise a generator unit 82 (FIG. 12) The generator unit 82 is spherical and, in particular, also supported in the shaft 12. Like the generator unit illustrated in FIG. 5, the generator unit 82 includes several coils 84 into which current is induced by the magnets 86.

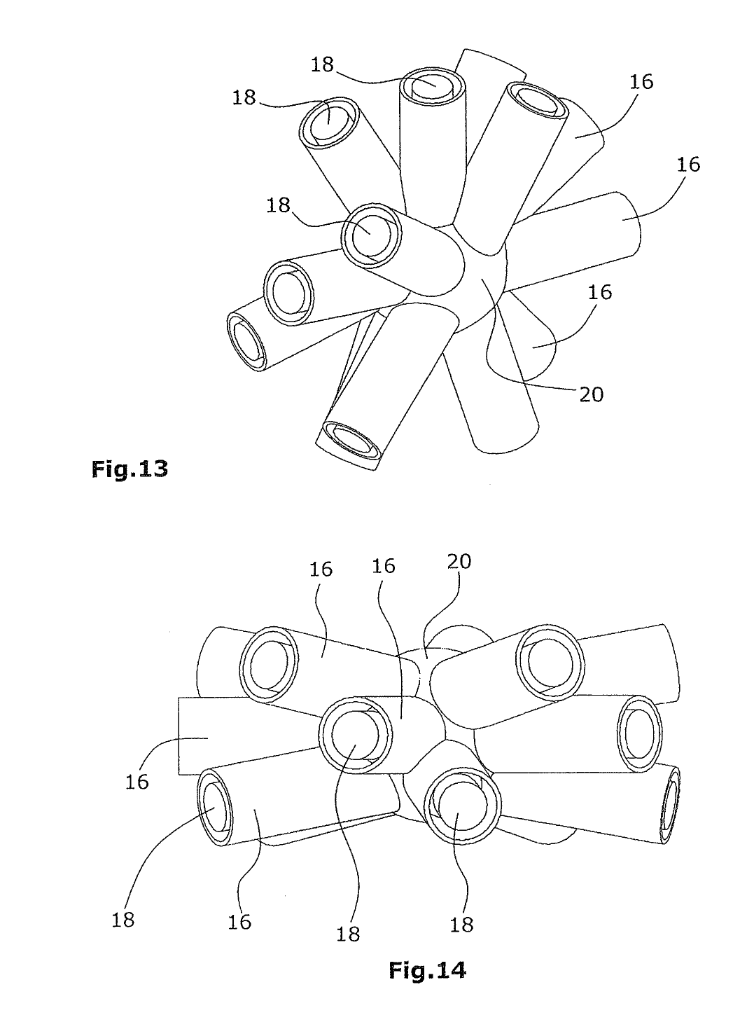

Instead of arranging the piston/cylinder means of the individual drive means in planes, the same may also be arranged spatially as illustrated in FIG. 13 or 14, for example. The individual pistons 18 located in the cylinders 16 again act on a power transmission surface (not illustrated) of a rotary element. The same may be enclosed by an especially spherical generator unit.

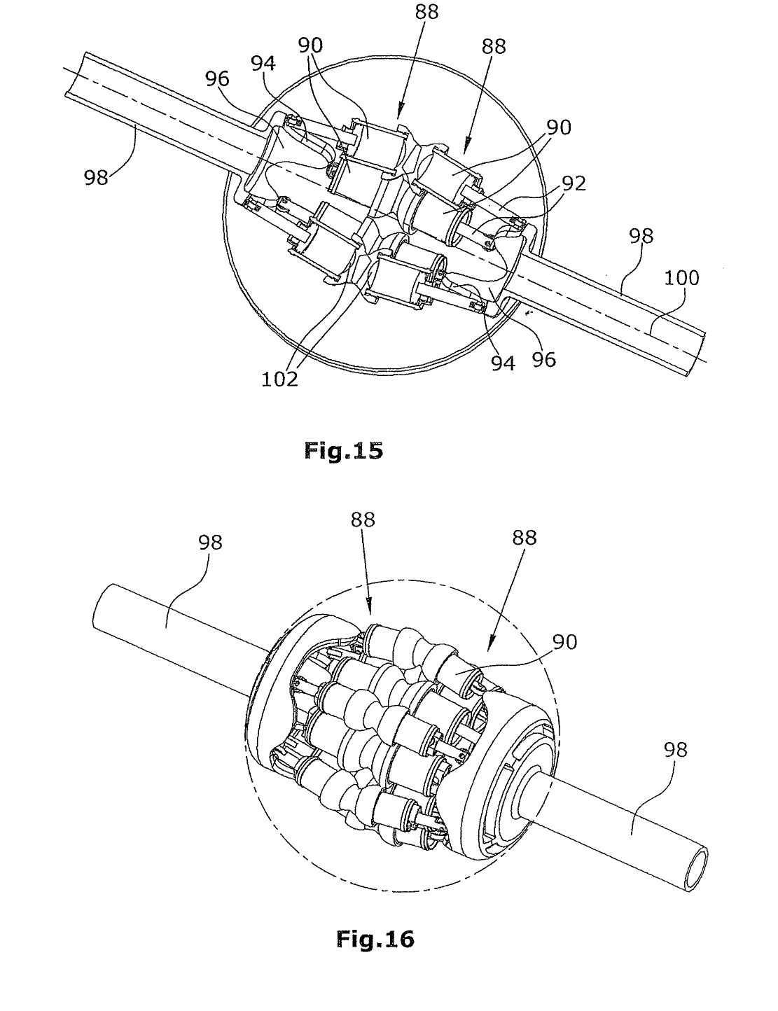

In another embodiment, which is an independent disclosure regarding a thermal engine, a plurality of power transmission means 88, i.e. two in the embodiment illustrate in FIG. 15, are provided. Each power transmission 88 comprises a plurality of piston/cylinder units 90. The pistons of the piston/cylinder units 90 are connected with a piston rod 92, respectively. The piston rods 92, in particular the free ends thereof, abut on a power transmission surface 94 of a substantially pot-shaped rotary element 96. The rotary element 96 is connected or integral with a shaft 98. Together with the shaft 98, the rotary element 96 rotates around the same longitudinal axis 100.

Since the power transmission surface 94 of the rotary element 96 has a corrugated or wave-shaped design and the piston/cylinder units 90 are arranged on a circular line surrounding the longitudinal axis 100 according to the troughs and crests of the wave-shaped power transmission surface, the corresponding pistons are situated at different positions, respectively, in particular at an upper dead center or a lower dead center, depending on the position of the piston/cylinder units 90 relative to the power transmission surface 94. An expansion in the expansion spaces 102 of the individual piston/cylinder units causes a movement of the piston rod 92 towards the rotary element 96.

The individual piston/cylinder units have different strokes, with a first group of piston/cylinder units having a longer stroke and a second group having a shorter stroke. The group with a shorter stroke is preferably driven by steam and the group having the larger stroke is driven by fuel. Accordingly, the power transmission surface has raised parts of different heights, so that the individual piston/cylinder units are urged to the upper dead center by different raised parts of the power transmission surface.

In a preferred development of the embodiment illustrated in FIG. 15 (FIG. 16), a total of four drive means 88 is provided. The two drive means 88 of the embodiment illustrated in FIG. 15 are respectively surrounded by a further drive means comprising a plurality of piston/cylinder units 90 arranged on a circle of larger diameter. In a preferred embodiment, the drive means 88 are configured as described above and, in particular, comprise piston/cylinder units with different strokes.

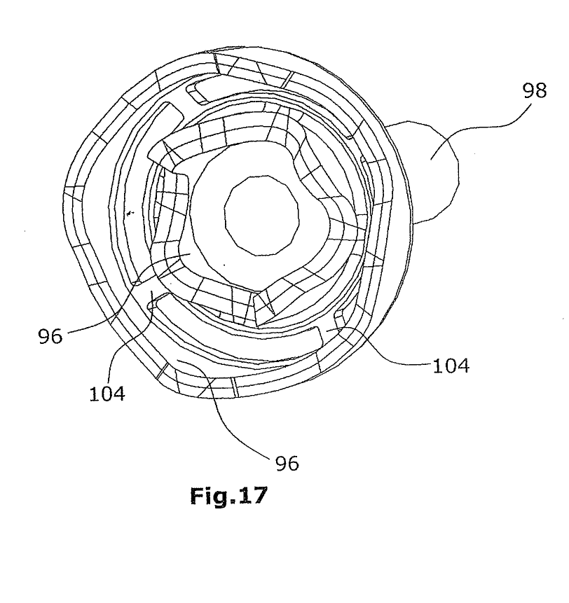

A separate rotary element 96 is provided per drive means 88, a rotary element 96 of smaller or larger diameter (FIG. 17) respectively being provided with the shaft 98. A pair of rotary elements 96, as illustrated in FIG. 17, is connected through webs 104. The two rotary elements 96 are connected with the shaft 98. It is further possible to provide more than two, especially concentrically arranged rotary elements 96.

Although the disclosure has been described and illustrated with reference to specific embodiments thereof, it is not intended that the disclosure be limited to those illustrative embodiments. Those skilled in that art will recognize that variations and modifications can be made without departing from the true scope of the disclosure as defined by the claims that follow. It is therefore intended to include within the disclosure all such variations and modifications as fall within the scope of the appended claims and equivalents thereof.

What is claimed is:

1. A thermal engine comprising
at least one drive means arranged within a common rotary element and driving said rotary element,
said drive means having a plurality of cylinders, each connected with a respective central expansion space, with pistons being provided in the cylinders,
the pistons being connected with the rotary element for driving the same, said pistons especially abutting on a power transmission surface of the rotary element.

2. The thermal engine of claim 1, wherein several drive means are provided, each having a common expansion space.

3. The thermal engine of claim 1, wherein at least three piston/cylinder means per drive means are arranged around said common expansion chamber, the arrangement in particular being star-shaped.

4. The thermal engine of claim 1, wherein the piston/cylinder means of each drive means are arranged in a plane, and wherein the planes of adjacent drive means are preferably parallel to each other.

5. The thermal engine of claim 1, wherein the rotary element comprises a power transmission surface of corrugated structure on which the piston heads of the pistons abut.

6. The thermal engine of claim 5, wherein, at a lower dead centre of the pistons, the piston heads abut on a bulge of the corrugated structure directed toward the expansion space.

7. The thermal engine of claim 1, wherein upon an outward directed displacement or expansion of the pistons, the piston heads slide into a recess of the corrugated structure in order to drive the rotary element.

8. The thermal engine of claim 1, wherein the pistons of a drive means move synchronously.

9. The thermal engine of claim 1, wherein preferably all piston cylinder means of a drive means are arranged offset by, in particular, the same angle with respect to all piston/cylinder means of an adjacent drive means.

10. The thermal engine of claim 6, wherein the bulges and the recesses of the rotary element of adjacent drive means are arranged offset relative to each other by, in particular, the same angle.

11. The thermal engine of claim 1, wherein the expansion spaces are at least partly designed as combustion spaces.

12. The thermal engine of claim 1, wherein the expansion spaces are at least partly designed as steam expansion spaces in which especially water vapor expands.

13. The thermal engine of claim 1, wherein said expansion spaces at least partly comprise a plurality of expansion chambers.

14. The thermal engine of claim 13, wherein steam expansion chamber partly surrounds a combustion chamber.

15. The thermal engine of claim 13, wherein the expansion chamber of an expansion space serves for the expansion of different media.

16. The thermal engine of claim 15. wherein the pistons of a drive means are connected with different power transmission surfaces of a rotary element.

17. A thermal engine comprising
a rotary element connected with a shaft and comprising a corrugated power transmission surface,
a drive means comprising at least one piston/cylinder unit,
wherein one piston rod of the at least one piston/cylinder unit abuts on the power transmission surface, and
wherein the piston rod is arranged substantially parallel to a longitudinal axis of the shaft.

18. The thermal engine of claim 17, wherein a plurality of piston/cylinder units is arranged around the longitudinal axis of the shaft.

19. The thermal engine of claim 17, wherein the drive means comprises a plurality of piston/cylinder units.

20. The thermal engine of claim 19, wherein the piston/cylinder unit with the shorter stroke comprises a steam expansion space.

21. The thermal engine of claim 19, wherein the piston/cylinder unit with the longer stroke comprises a combustion space.

22. The thermal engine of claim 17, wherein the power transmission surface is orientated substantially perpendicular to the longitudinal axis of the shaft.

23. The thermal engine of claim 17, wherein a plurality of drive means, respectively comprising at least one piston/cylinder unit, is provided that respectively cooperates with a separate rotary element.

24. The thermal engine of claim 23, wherein an inner drive means is surrounded by an outer drive means, both drive means being arranged on a circular line.

25. The thermal engine of claim 23, wherein at least two, respectively opposite drive means are provided, whose piston rods are directed in opposite directions, at least two rotary elements being provided that are connected with two different shafts.

26. The thermal engine of claim 1, wherein a generator unit is provided that is connected with the rotary element or the shaft and, surrounds said rotary element or said shaft.

27. The thermal engine of claim 1, wherein a compact thermal engine is formed by coupling the steam expansion spaces and the combustion spaces.
